(19) United States
(12) Patent Application Publication
(10) Pub. No.: US 2015/0137760 A1
(43) Pub. Date: May 21, 2015

(54) HOLDING STRUCTURE

(71) Applicant: Wistron Corporation, New Taipei City (TW)

(72) Inventor: Hung-Sen Yang, New Taipei City (TW)

(73) Assignee: Wistron Corporation, New Taipei City (TW)

(21) Appl. No.: 14/151,831

(22) Filed: Jan. 10, 2014

(30) Foreign Application Priority Data
Nov. 18, 2013 (TW) 102221518

(51) Int. Cl. G06F 1/16; F16M 13/02; H02J 7/00; F16M 11/04

(52) U.S. Cl. CPC G06F 1/16; F16M 11/041; F16M 13/022; H02J 7/0044
USPC 320/115; 248/222.11

(57) ABSTRACT

A holding structure adapted to an electronic device is provided. The holding structure includes a base, a carrying component and a position-limiting component. The carrying component is pivoted to the base and adapted to carry the electronic device. The position-limiting component is pivoted to the base. When the electronic device receives a force to move toward the base and lean against the base with the pivoting of the carrying component, the position-limiting component is driven by the electronic device to move to a second position from a first position. When the position-limiting component is located at the second position, the position-limiting component limits the electronic device at the base.

### CROSS-REFERENCE TO RELATED APPLICATION

This application claims the priority benefit of Taiwan application serial no. 102221518, filed on Nov. 18, 2013. The entirety of the above-mentioned patent application is hereby incorporated by reference herein and made a part of this specification.

### BACKGROUND

1. Field of the Invention

The invention is directed to a holding structure and more particularly, to a holding structure for holding an electronic device.

2. Description of Related Art

In the modern information era, electronic products have developed an indispensable relationship with modern human life. Along with continual development of electronic technology, user-friendly handheld electronic products with powerful functions, such as tablet PCs and smart phones have come forth and gradually replaced old electronic products, which has gradually become indispensable tools in daily life due to the convenience and portability.

In order to allow a user to conveniently use a handheld electronic device while driving, a car charger holder can be equipped in the car for holding and charging the handheld electronic device. However, under the designs of the currently available car charger holders, a user has to use both hands to either mount the handheld electronic device to a car charger holder and to take away the handheld electronic device from the car charger holder, which leads to driving unsafety and increase of risks of traffic accidents.

### SUMMARY

The invention is directed to a holding structure that is convenient for a user to mount an electronic device to the holding structure with one hand.

The invention is directed to a holding structure adapted to an electronic device. The holding structure includes a base, a carrying component and a position-limiting component. The carrying component is pivoted to the base and adapted to carry the electronic device. The position-limiting component is pivoted to the base. When the electronic device receives a force to move toward the base and lean against the base with the carrying component, the position-limiting component is driven by the electronic device to move to a second position from a first position. When the position-limiting component is located at the second position, the position-limiting component limits the electronic device at the base.

In an embodiment of the invention, when the position-limiting component receives a force to move to the first position from the second position, the electronic device is released by the position-limiting component and adapted to expand from the main body with the pivoting of the carrying component.

In an embodiment of the invention, the base includes a main body and a first elastic component. The carrying component is pivoted to the main body, and the position-limiting component is pivoted to the main body. The first elastic component is connected between the main body and the carrying component. The carrying component is adapted to pivot by an elastic force of the first elastic component to drive the electronic device to expand from the main body.

In an embodiment of the invention, the base includes a main body and a second elastic component. The carrying component is pivoted to the main body, and the position-limiting component is pivoted to the main body. The second elastic component is connected between the main body and the position-limiting component. The position-limiting component is adapted to move toward the second position by an elastic force of the second elastic component.

In an embodiment of the invention, when the electronic device moves toward the main body with the pivoting of the carrying component, the electronic device resists the elastic force of the second elastic component and pushes the position-limiting component to the first position, and when the electronic device moves across the position-limiting component and leans against the main body, position-limiting component, the position-limiting component moves to the second position from the first position by the elastic force of the second elastic component.

In an embodiment of the invention, the holding structure further includes a positioning assembly disposed on the main body. The positioning assembly and adapted to resist the elastic force of the second elastic component to position the position-limiting component at the first position. When the electronic device moves toward the main body and leans against the main body with the pivoting of the carrying component, the electronic device pushes the positioning assembly, such that the position-limiting component is released by the positioning assembly and moves to the second position from the first position by the elastic force of the second elastic component.

In an embodiment of the invention, the positioning assembly includes a positioning component and a third elastic component. The positioning component is movably disposed on the main body. The third elastic component is connected between the main body and the positioning component. The positioning component is adapted to position the position-limiting component at the first position by an elastic force of the third elastic component. The electronic device is adapted to resist the elastic force of the third elastic component to push the positioning component, such that the position-limiting component is released by the positioning assembly and moves to the second position from the first position by the elastic force of the second elastic component. When the position-limiting component is located at the first position and the electronic device moves away from the positioning component, the positioning component returns back and positions the position-limiting component by the elastic force of the third elastic component.

In an embodiment of the invention, the position-limiting component has a first engagement part, and the positioning component has a second engagement part, a sliding part and a pressing part. The sliding part is connected between the second engagement part and the pressing part and slidably disposed on the main body. The third elastic component is connected between the pressing part and the main body. The second engagement part is adapted to be engaged with the first engagement part by the elastic force of the third elastic component. The electronic device is adapted to resist the elastic force of the third elastic component to push the pressing part and drives the sliding part to slide relatively to the main body, such that the second engagement part moves away from the first engagement part.

In an embodiment of the invention, the carrying component has a containing concave, and a bottom of the electronic device is adapted to be contained in the containing concave.

In an embodiment of the invention, the base has a connection port and is adapted to be electrically connected to an external power supply. When the electronic device leans against the base, the electronic device is connected to the connection port and receives electricity from the external power supply through the connection port.

Based on the above, the holding structure of the invention has the carrying component and the position-limiting component that are pivoted to the base. The user can use the carrying component to carry the electronic device and push the electronic device toward the base, such that the electronic device leans against the base with the pivoting of the carrying component and drives the position-limiting component to pivot, and thereby, the position-limiting component limits the electronic device at the base. In the aforementioned operation, the operations of the carrying component and the position-limiting component are achieved by the driving of the electronic device, and therefore, the user can successfully mounting the electronic device to the holding structure merely by pushing the electronic device with one hand without operating with both hand, and thereby, the convenience of operating the holding structure can be improved.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a holding structure according to an embodiment of the invention.

FIG. 2A through FIG. 2D are operational flowcharts of the holding structure illustrated in FIG. 1.

FIG. 3 is a perspective view of the holding structure and the electronic device illustrated in FIG. 2C.

FIG. 4 is a perspective view of the holding structure and the electronic device illustrated in FIG. 2D.

FIG. 5A and FIG. 5B are flowcharts of a holding structure and an electronic device according to another embodiment of the invention.

FIG. 6 is a perspective view of the holding structure and the electronic device illustrated in FIG. 5A.

FIG. 7 is a perspective view of the holding structure and the electronic device illustrated in FIG. 5B.

FIG. 8 is a partially cross-sectional view of the holding structure illustrated in FIG. 5A.

FIG. 9 is a partially cross-sectional view of the holding structure and the electronic device illustrated in FIG. 5B.

### DESCRIPTION OF EMBODIMENTS

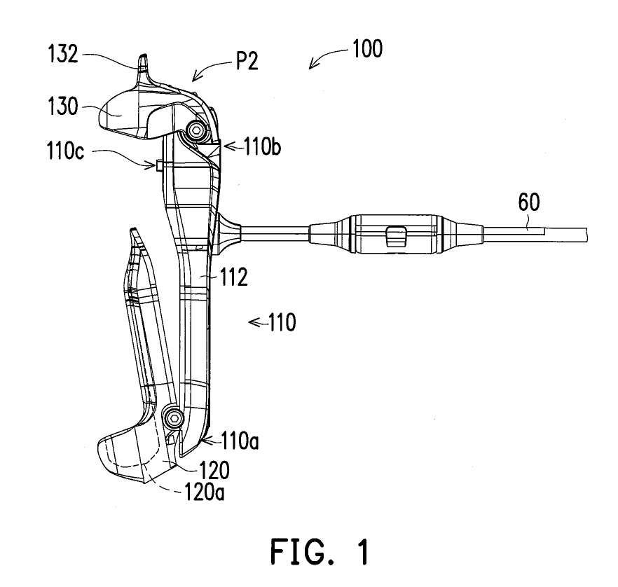

FIG. 1 is a side view of a holding structure according to an embodiment of the invention. A holding structure 100 of the present embodiment is a, for example, a car charging dock and includes a base 110, a carrying component 120 and a position-limiting component 130. The base 110 has a bottom portion 110a and a top portion 110b that are opposite to each other. The carrying component 120 is pivoted to a bottom portion 110a of the base 110, and the position-limiting component 130 is pivoted to the top portion 110b of the base 110.

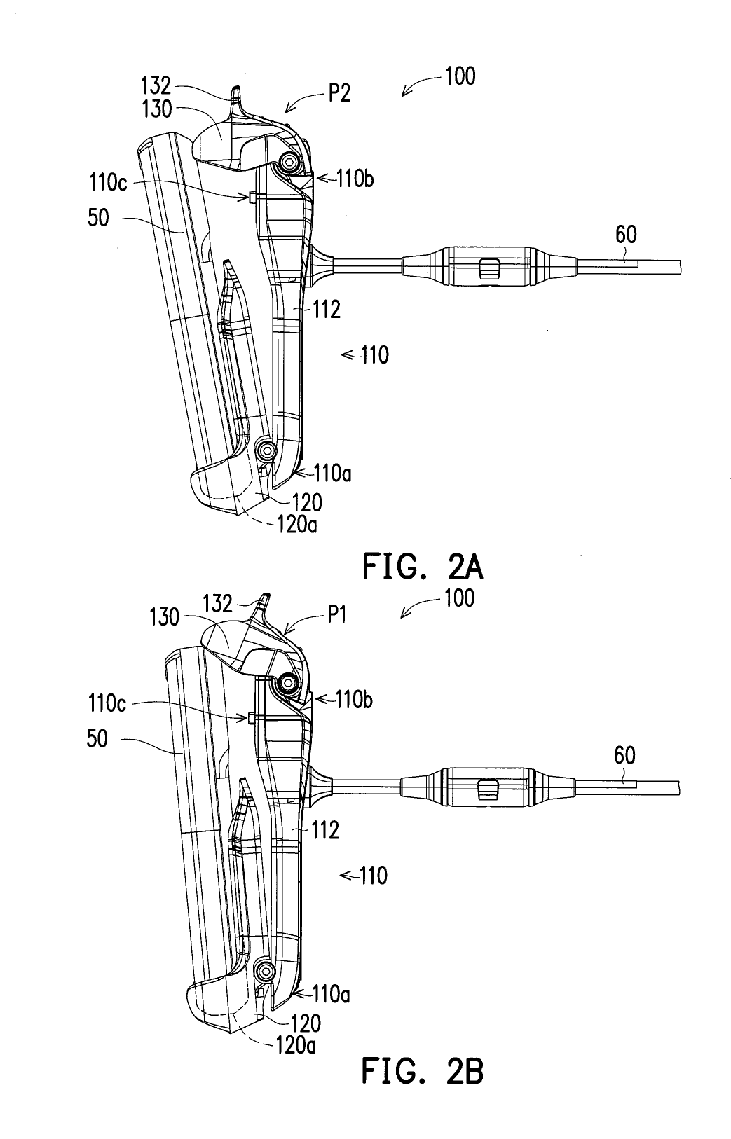

FIG. 2A through FIG. 2D are operational flowcharts of the holding structure illustrated in FIG. 1. A user may place an electronic device 50, e.g., a smart phone, in the carrying component 120 as illustrated in FIG. 2A and pushes the electronic device 50 toward the base 110, as illustrated in FIG. 2B through FIG. 2C. During the operation process illustrated in FIG. 2B through FIG. 2C, when the electronic device 50 receives a force, moves toward and lean against the base 110 with pivoting of the carrying component 120, the position-limiting component 130 is driven by the electronic device 50 to move from a first position P1 illustrated in FIG. 2B to a second position P2 illustrated in FIG. 2C, and at this time, the position-limiting component 130 limits the electronic device 50 at the base 110.

When wanting to remove the electronic device 50 from the holding structure 100 as illustrated in FIG. 2C, the user may apply a force to a protrusion 132 of the position-limiting component 130, such that the position-limiting component 130 moves from the second position P2 illustrated in FIG. 2C to the first position P1 illustrated in FIG. 2D. At this time, the electronic device 50 is released by the position-limiting component 130 and adapted to expand from the base 110 with the pivoting of the carrying component 130, and thereby, the user may remove the electronic device 50 from the carrying component 120.

During the operation process illustrated in FIG. 2A through FIG. 2C, the carrying component 120 and the position-limiting component 130 are operated by the driving of the electronic device 50, and thus, by pushing the electronic device 50 with only one hand, the user may mount the electronic device 50 to the holding structure 100 successfully. Additionally, during the operation process illustrated in FIG. 2C through FIG. 2D, by the user applying the force to position-limiting component 130 with only one hand, the electronic device 50 may be successfully released by the position-limiting component 130 to be taken away. Thereby, the user may assemble/disassemble the electronic device 50 to/from the holding structure 100 without using both hands, such that the driving safety can be improved and the probability of traffic accidents can be reduced.

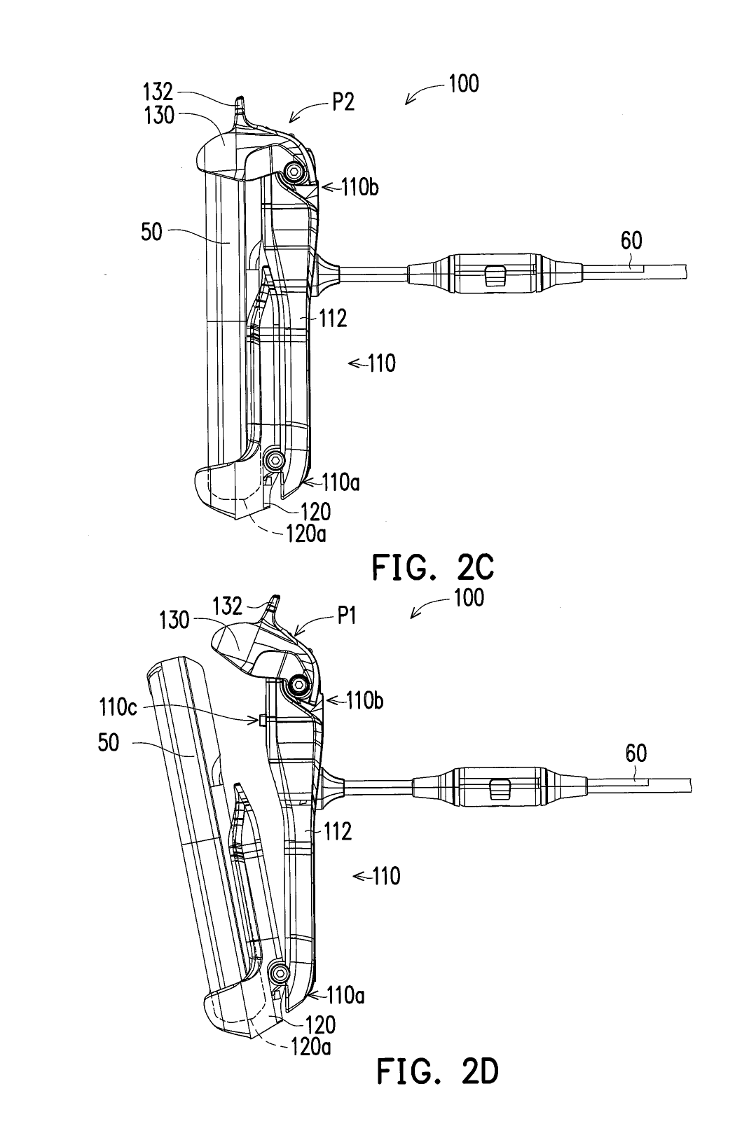

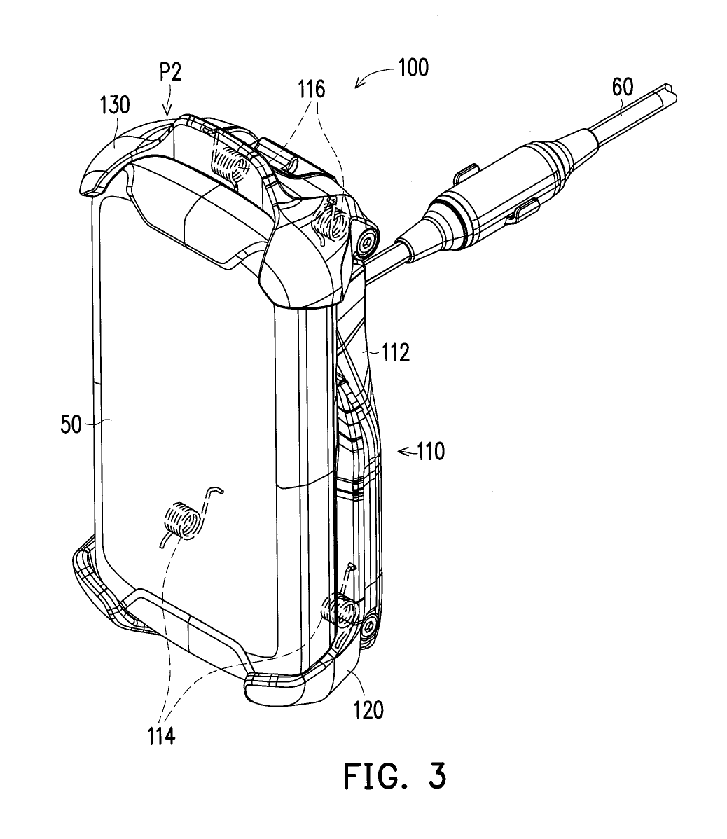

FIG. 3 is a perspective view of the holding structure and the electronic device illustrated in FIG. 2C. FIG. 4 is a perspective view of the holding structure and the electronic device illustrated in FIG. 2D. With reference to FIG. 3 and FIG. 4, to be more detailed, the base 110 of the present embodiment includes a main body 112, at least one first elastic component 114 (which is illustrated as two herein) and at least one second elastic component 116 (which is illustrated as two herein). The carrying component 120 is pivoted to the main body 112, and the position-limiting component 130 is pivoted to the main body 112. Each first elastic component 114 is, for example, a torsion spring and connected between the main body 112 and the carrying component 120. The carrying component 120 is adapted to pivot by an elastic force of each first elastic component 114 to drive the electronic device 50 to expand from the main body 112, as illustrated in FIG. 2A and FIG. 2D. Each second elastic component 116 is, for example, a torsion spring and connected between the main body 112 and the position-limiting component 130. The position-limiting component 130 is adapted to move toward the second position P2 by an elastic force of each second elastic component 114, as illustrated in FIG. 1, FIG. 2A and FIG. 2C.

During the process of the electronic device 50 resisting the elastic force of each first elastic component 114 (illustrated in FIG. 3 and FIG. 4) to move toward the main body 112 with the pivoting of the carrying component 120 as illustrated in FIG. 2A through FIG. 2C, the electronic device 50 resisting the elastic force of each second elastic component 116 (illustrated in FIG. 3 and FIG. 4) to push the position-limiting component 130 to the first position P1 illustrated in FIG. 2B. When the electronic device 50 moves across the position-limiting component 130 to lean against the main body 112 as illustrated in FIG. 2C and FIG. 3, the position-limiting component 112 moves to the second position P2 from the first position P1 by the elastic force of each second elastic component 116 to limit the electronic device 50 on the main body 112. When the user push the position-limiting component 130 to the second position P2 by resisting the elastic force of each second elastic component 116, as illustrated in FIG. 2D and FIG. 4, the electronic device 50 is released, and the carrying component 120 pivots by the elastic force of each first elastic component 114 to drive the electronic device 50 to expand from the main body 112, such that the user may take away the electronic device 50 from the carrying component 120.

With reference to FIG. 1 and FIG. 2A through FIG. 2D, the carrying component 120 of the present embodiment has a containing concave 120a. The bottom portion of the electronic device 50 is adapted to be contained in the containing concave 120a, such that the electronic device 50 may be stably carried on the carrying component 120 and prevented from accidentally departing from carrying component 120 during the pivoting process of the carrying component 120.

In the present embodiment, the holding structure 100 has a capability of charging the electronic device 50. To be more specific, with reference to FIG. 4, the base 110 has a connection port 110c and is adapted to be electrically connected to an external power supply (not shown) through a wire 60. When the electronic device 50 leans against the main body 112 of the base 110 as illustrated in FIG. 2C and FIG. 3, the electronic device 50 is connected to the connection port 110c and receive electricity from the external power supply through the connection port 110c for charging.

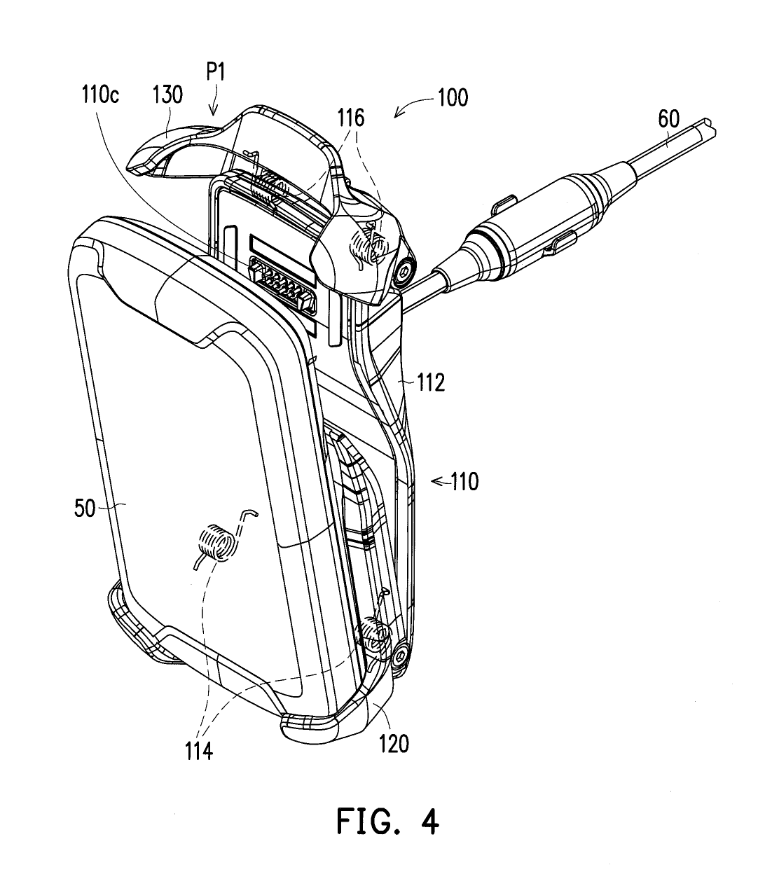

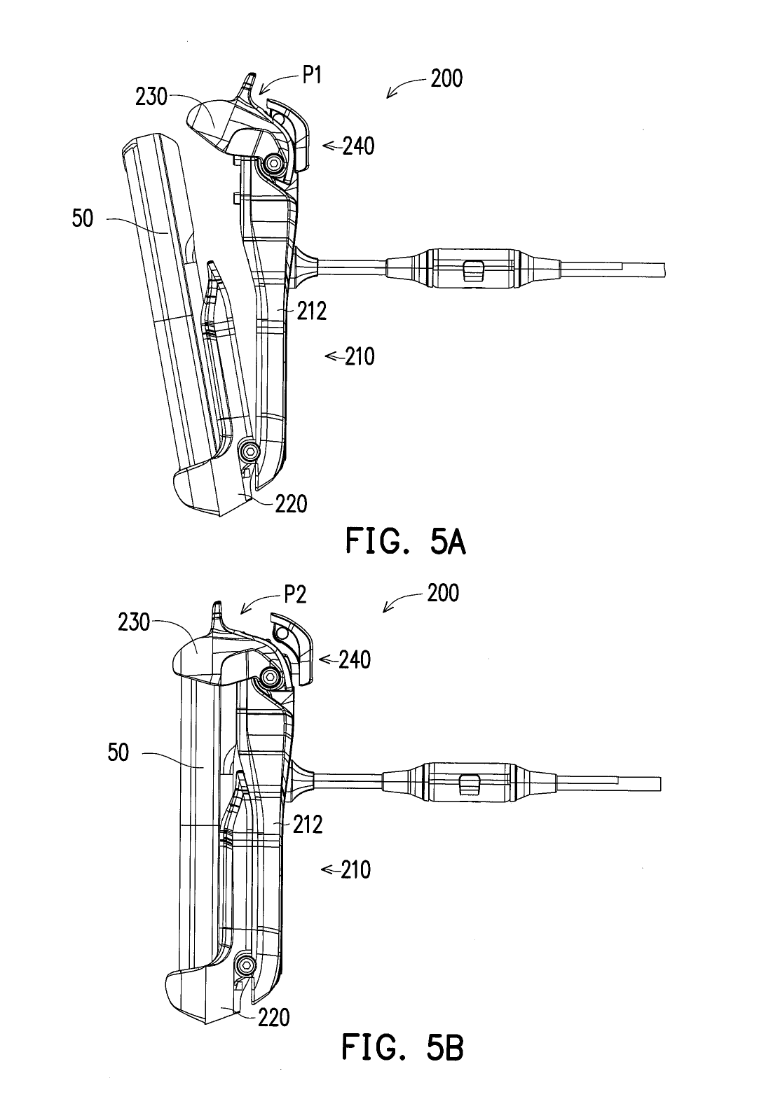

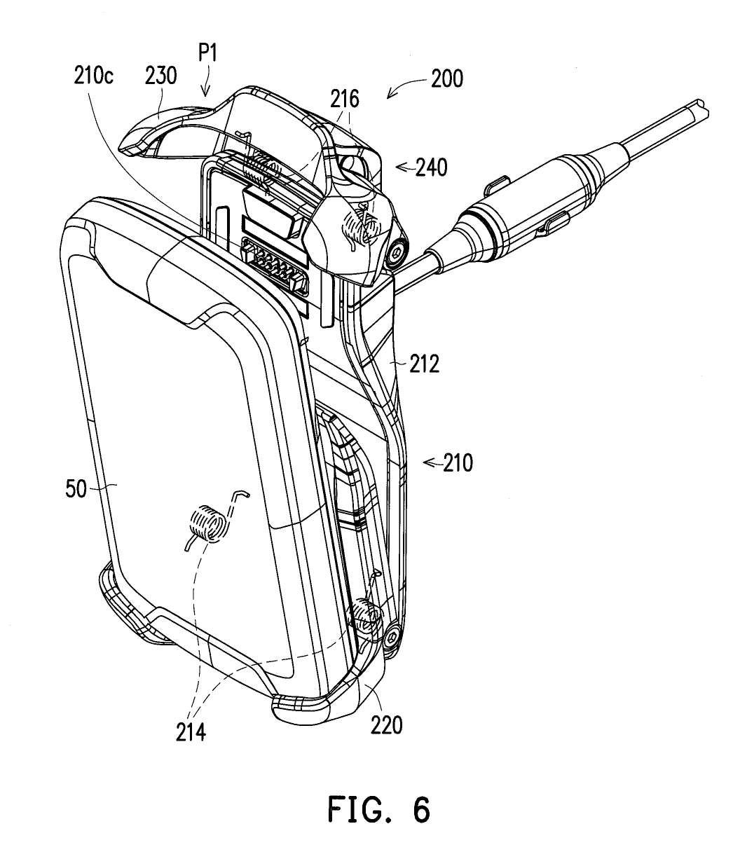

The invention is not intent to limit the operation of the position-limiting component, and several examples are illustrated with reference to drawings as below. FIG. 5A and FIG. 5B are flowcharts of a holding structure and an electronic device according to another embodiment of the invention. FIG. 6 is a perspective view of the holding structure and the electronic device illustrated in FIG. 5A. FIG. 7 is a perspective view of the holding structure and the electronic device illustrated in FIG. 5B. With reference to FIG. 5A, FIG. 5B, FIG. 6 and FIG. 7, in a holding structure 200, a base 210, a connection port 210c, a main body 212, first elastic components 214, second elastic components 216, a carrying component 220 and a position-limiting component 230 are disposed in a manner similar to the disposition of the base 110, the connection port 110c, the main body 112, the first elastic components 114, the second elastic components 116, the carrying component 120 and the position-limiting component 130 in the aforementioned embodiment, and will not be repeated described. The holding structure 200 is different from the holding structure 100 in further including a positioning assembly 240. The positioning assembly 240 is disposed on the main body 212 and adapted to resist the elastic force of each second elastic component 216 to position the position-limiting component 230 at the first position P1 as illustrated in FIG. 5A and FIG. 6.

When the electronic device 50 moves toward the main body 212 with the pivoting of the carrying component 220 and leans against the main body 212 as illustrated in FIG. 5B and FIG. 7, the electronic device 50 pushes the positioning assembly 240, such that the position-limiting component 230 is released by the positioning assembly 240 to move from the first position P1 to the second position P2 by the elastic force of each second elastic component 216 to limit the electronic device 50 on the main body 212 of the base 210. In such disposition, the position-limiting component 230 may be positioned in the first position P1 by the positioning assembly 240, and thus, during the process of the electronic device 50 leaning against the base 210 with the pivoting of the carrying component 220, the electronic device 50 may push the position-limiting component 230 without resisting the elastic force of each second elastic component 216 to prevent the electronic device 50 from being damaged due to contacting with the position-limiting component 230. Detail structures and operations of the positioning assembly 240 will be specifically described as follows.

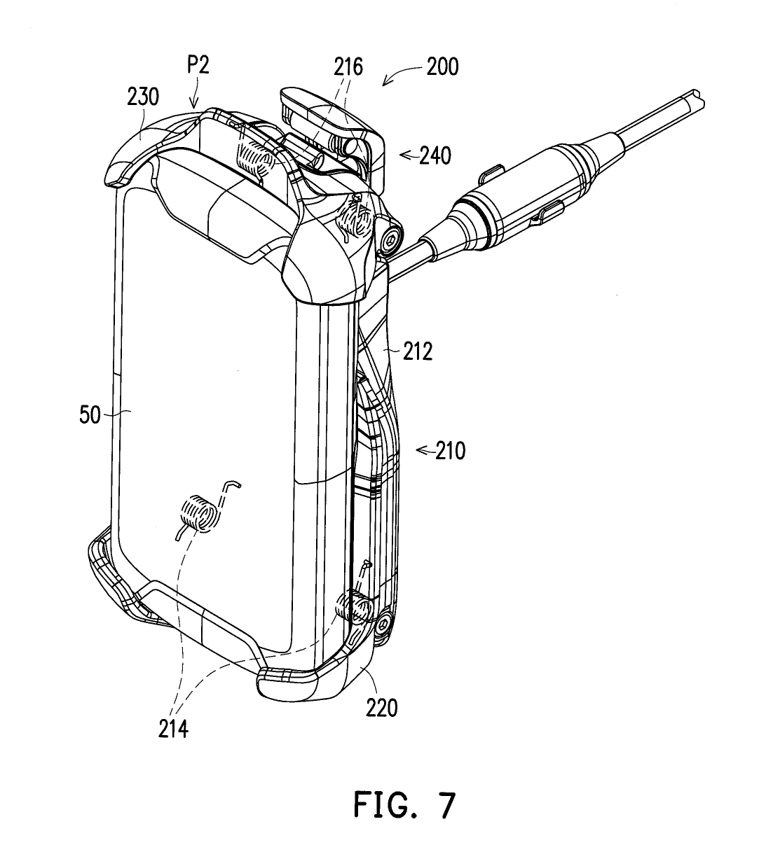

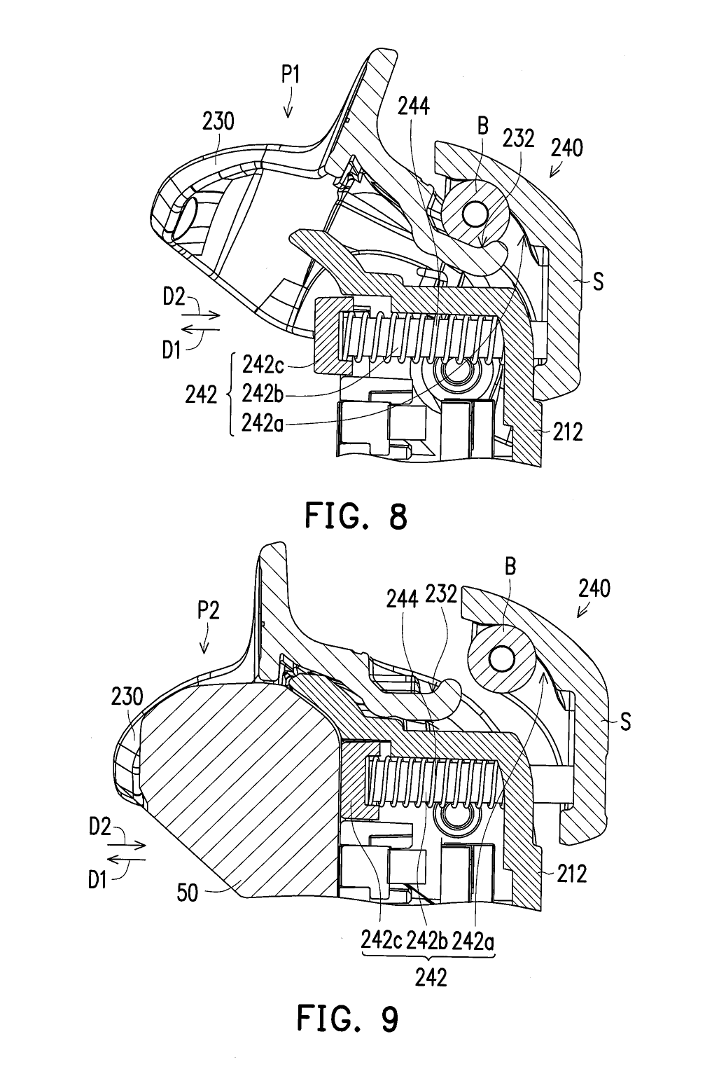

FIG. 8 is a partially cross-sectional view of the holding structure illustrated in FIG. 5A. FIG. 9 is a partially cross-sectional view of the holding structure and the electronic device illustrated in FIG. 5B. With reference to FIG. 8 and FIG. 9, the position-limiting component 230 of the present embodiment, has a first engagement part 232. The first engagement part 232 is, for example, concave-shaped. The positioning assembly 240 includes a positioning component 242 and a third elastic component 244. The positioning component 242 has a second engagement part 242a, a sliding part 242b and a pressing part 242c. The second engagement part 242a is composed of, for example, a shell body S and a protruding structure B. The sliding part 242b is connected between the second engagement part 242a and the pressing part 242c and slidably disposed on the main body 212, such that the positioning component 242 may be movably disposed on the main body 212. The third elastic component 244 is, for example, a compression spring and connected between the positioning component 242 and the pressing part 242c of the main body 212.

When the positioning assembly 240 and the position-limiting component 230 are in a state illustrated in FIG. 8, the third elastic component 244 pushes the pressing part 242c by its elastic force along a direction D1, such that the protruding structure B of the second engagement part 242a is engaged with the first engagement part 232 by the elastic force of the third elastic component 244 to position the position-limiting component 230 at the first position Pl. At this time, the shell body S of the second engagement part 242a abuts against the main body 212 to prevent the positioning component 242 from being excessively displaced along the direction D1. When the electronic device 50 leans against the main body 212 as illustrated in FIG. 9, the electronic device 50 resist the elastic force of the third elastic component 244 to push the pressing part 242c of the positioning component 242 along a direction D2 to drive the sliding part 242b to slide relatively to the main body 212, such that the second engagement part 242a moves away from the first engagement part 232. At this time, the position-limiting component 230 is released by the positioning assembly 240 and moves from the first position P1 to the second position P2 by the elastic force of the second elastic component 216 (illustrated in FIG. 6 and FIG. 7) to limit the electronic device 50 at the main body 212. When desiring to take away the electronic device 50, the user may apply a force to the position-limiting component 230 to make the position-limiting component 230 move to the first position P1 as illustrated in FIG. 6. When the position-limiting component 230 is located at the first position P1, the electronic device 50 is released to moves away from the pressing part 242c of the positioning component 242 by the elastic force of each first elastic component 214 (illustrated in FIG. 6 and FIG. 7) with the pivoting of the carrying component 220, and the positioning component 242 returns back to the state illustrated in FIG. 8 by the elastic force of the third elastic component 244 to position the position-limiting component 230 at the first position P1. In this situation, the user may take away the electronic device 50 from the carrying component 220.

In view of the foregoing, the holding structure of the invention has the carrying component and the position-limiting component that are pivoted to the base. When the user wants to assemble the electronic device to the holding structure, he/she can have the electronic device to be carried on the carrying component and push electronic device toward the base, such that the electronic device leans against the base with the pivoting of the carrying component and drives the position-limiting component to pivot so as to limit the electronic device at the base with the position-limiting component. When desiring to take away the electronic device from the holding structure, the user can apply a force to the position-limiting component, such that the electronic device is released to expand from the base with the pivoting of the carrying component and thereby, the user can conveniently take away the electronic device from the carrying component. During the operation process of assembling the electronic device to the holding structure, the carrying component and the position-limiting component are operated by the driving of the electronic device, and thus, the user can successfully mount the electronic device to the holding structure by pushing electronic device with only one hand. Additionally, in the operation of taking away the electronic device from the holding structure, by the user applying the force to the position-limiting component with only one hand, the electronic device can be successfully released by and taken away from the position-limiting component. By doing so, the user can assemble/disassemble the electronic device to/from the holding structure without using both hands, such that the operational convenience of the holding structure can be improved.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A holding structure, adapted to an electronic device, the holding structure comprising:
a base;
a carrying component, pivoted to the base and adapted to carry the electronic device; and
a position-limiting component, pivoted to the base, wherein when the electronic device receives a force to move toward the base and lean against the base with the pivoting of the carrying component, the position-limiting component is driven by the electronic device to move to a second position from a first position, and when the position-limiting component is located at the second position, the position-limiting component limits the electronic device at the base.

2. The holding structure according to claim 1, wherein when the position-limiting component receives a force to move to the first position from the second position, the electronic device is released by the position-limiting component and adapted to expand from the main body with the pivoting of the carrying component.

3. The holding structure according to claim 1, wherein the base comprises:
a main body, wherein the carrying component is pivoted to the main body, and the position-limiting component is pivoted to the main body; and
a first elastic component, connected between the main body and the carrying component, wherein the carrying component is adapted to pivot by an elastic force of the first elastic component to drive the electronic device to expand from the main body.

4. The holding structure according to claim 1, wherein the base comprises:
a main body, wherein the carrying component is pivoted to the main body, and the position-limiting component is pivoted to the main body; and
a second elastic component, connected between the main body and the position-limiting component, wherein the position-limiting component is adapted to move toward the second position by an elastic force of the second elastic component.

5. The holding structure according to claim 4, wherein when the electronic device moves toward the main body with the pivoting of the carrying component, the electronic device resists the elastic force of the second elastic component and pushes the position-limiting component to the first position, and when the electronic device moves across the position-limiting component and leans against the main body, the position-limiting component moves to the second position from the first position by the elastic force of the second elastic component.

6. The holding structure according to claim 4, further comprising:
a positioning assembly, disposed on the main body and adapted to resist the elastic force of the second elastic component to position the position-limiting component at the first position, wherein when the electronic device moves toward the main body and leans against the main body with the pivoting of the carrying component, the electronic device pushes the positioning assembly, such that the position-limiting component is released by the positioning assembly and moves to the second position from the first position by the elastic force of the second elastic component.

7. The holding structure according to claim 6, wherein the positioning assembly comprises:
a positioning component, movably disposed on the main body; and
a third elastic component, connected between the main body and the positioning component, wherein the positioning component is adapted to position the position-limiting component at the first position by an elastic force of the third elastic component, the electronic device is adapted to resist the elastic force of the third elastic component to push the positioning component, such that the position-limiting component is released by the positioning assembly and moves to the second position from the first position by the elastic force of the second elastic component, and when the position-limiting component is located at the first position and the electronic device moves away from the positioning component, the positioning component returns back and positions the position-limiting component by the elastic force of the third elastic component.

8. The holding structure according to claim 7, wherein the position-limiting component has a first engagement part, and the positioning component has a second engagement part, a sliding part and a pressing part, wherein the sliding part is connected between the second engagement part and the pressing part and slidably disposed on the main body, the third elastic component is connected between the pressing part and the main body, the second engagement part is adapted to be engaged with the first engagement part by the elastic force of the third elastic component, and the electronic device is adapted to resist the elastic force of the third elastic component to push the pressing part and drives the sliding part to slide relatively to the main body, such that the second engagement part moves away from the first engagement part.

9. The holding structure according to claim 1, wherein the carrying component has a containing concave, and a bottom of the electronic device is adapted to be contained in the containing concave.

10. The holding structure according to claim 1, wherein the base has a connection port and is adapted to be electrically connected to an external power supply, and when the electronic device leans against the base, the electronic device is connected to the connection port and receives electricity from the external power supply through the connection port.
